(19) United States
(12) Patent Application Publication
(10) Pub. No.: US 2009/0322468 A1
(43) Pub. Date: Dec. 31, 2009

(54) Chip Resistor and Manufacturing Method Thereof

(75) Inventors: Toshihiro Hanaoka, Nagano (JP); Shinji Murase, Nagano (JP)

Correspondence Address: CROWELL & MORING LLP;INTELLECTUAL PROPERTY GROUP, P.O. BOX 14300, WASHINGTON, DC, 20044-4300, US

(73) Assignee: KOA Corporation, Ina-shi, Nagano (JP)

(21) Appl. No.: 11/916,625

(22) PCT Filed: Jun. 1, 2006
(86) PCT No.: PCT/JP2006/311017

§ 371 Date: Jun. 9, 2009

(30) Foreign Application Priority Data
Jun. 6, 2005 (JP) 2005-165672

(51) Int. Cl. H01C 1/012; H01C 17/00

(52) U.S. Cl. 338/309; 29/610.1

(57) ABSTRACT

[Problem] To provide a chip resistor and a method for manufacturing thereof, the chip resistor keeping easily soldering strength even if mounted in a horizontal position, and never projects from a holding recess of a positioning jig in a mounting process, and further does not hinder miniaturization thereof from being promoted, while keeping a good appearance thereof.

[Means of Solution] In manufacturing a chip resistor 10, front-face electrodes 12 and resisters 13 are formed on the front face 20a of a large size substrate 20, and rear-face electrodes 16 are formed on the rear face 20b of the large size substrate 20. When the rear-face electrodes are formed, the rear-face electrodes 16 are extended to inclined faces of V-shaped grooves of second dividing grooves 22 on the rear face 20b and these extended parts are made to be side-face electrodes 16a. Then, the large size substrate 20 is divided along first dividing grooves 21 into strip substrates, and, after end-face electrodes 17 are formed on divided faces thereof by sputtering, the strip substrates 24 are divided along the second dividing grooves 22 and subjected to a plating process to provide an approximately square-prism shaped chip resistor 10 with electrodes exposed on each side face thereof.

### TECHNICAL FIELD

The present invention relates to a rectangular chip resistor bulk-mounted by a multi-mounting method, and a method for manufacturing thereof.

### BACKGROUND ART

Recently, a technology to bulk-mount chip components such as chip resistors by a multi-mounting method has been widely used. In such a multi-mounting method, a positioning jig called a template, which is provided with a number of holding recesses arranged according to an arrangement on a circuit board, is used, and, after each corresponding chip component has been fed into each of the holding recesses of this positioning jig via a transferring tube, the chip component in each of the holding recesses is mounted on the circuit board at the same time by a mounter with a sucking nozzle, resulting in a significant improvement in mounting speed.

FIG. 9 is a perspective view of a conventional rectangular chip resistor conforming to such a multi-mounting method (refer to the patent reference 1, for example). A chip resistor 1 shown in the drawing includes an insulating substrate 2 with a rectangular solid shape made of ceramic and the like, a pair of front-face electrodes 3 provided on the upper face of this insulating substrate 2 at both ends in the longitudinal direction thereof in the drawing, a resistor (not shown in the drawing) provided on the same upper face of the insulating substrate 2 in the drawing and both ends of which overlap the pair of front-face electrodes 3, a protecting layer 4 covering this resistor, a pair of rear-face electrodes (not shown in the drawing) provided on the lower face of the insulating substrate 2 at both ends in the longitudinal direction thereof in the drawing, and a pair of end-face electrodes 6 provided on both end faces of the insulating substrate 2 for bridge-connecting the front-face electrodes 3 and the rear-face electrodes, and side-face electrodes 7 extended from the end-face electrodes 6 are formed at the four corners in each side face of the insulating substrate 2. Note that these front-face electrodes 3, rear-face electrodes, end-face electrodes 6, and side-face electrodes 7 are covered by a plating layer (not shown in the drawing).

A method for manufacturing the chip resistor 1 shown in FIG. 9 is described briefly as follows. First, a large size substrate, on both front face and rear face of which dividing groves are formed in a matrix, is prepared, and the front-face electrodes 3, the rear-face electrodes, the resistors, the protecting layer 4, etc. are formed for a number of chips on this large size substrate. Next, the large size substrate is divided along first dividing grooves into strip substrates. Then, after the end-face electrodes 6 have been formed on divided faces thereof, the strip substrates are divided along second dividing grooves into pieces, and a number of chip resistors 1 are obtained by subjecting the pieces to a plating process. Here, when the end-face electrodes 6 are formed on the strip substrates, conductive paste is coated on the divided faces along the first dividing grooves using a roller or the like. At this time, a small amount of the conductive paste can be made to flow into the second dividing grooves crossing the first dividing grooves, and then, by baking the strip substrates, the side-face electrodes 7 can be formed within the second dividing grooves at both ends thereof, while the end-face electrodes 6 are formed on the divided faces. Therefore, when this strip substrates are divided along the second dividing grooves into pieces, the side-face electrodes 7 have been arranged on each of the side faces along the longitudinal direction of the pieces at the four corners thereof.

When the conventional chip resistor 1 manufactured in this manner is fed into a holding recess of a positioning jig (template) from a transferring tube in a mounting process by a multi-mounting method, it is easy to keep soldering strength, even if the chip resistor within this holding recess is in a horizontal position with a side face of the insulating substrate 2 facing downward, since the side-face electrodes 7 can be mounted on solder lands of a circuit board to be soldered. That is, when a commonly used rectangular chip resistor, which scarcely has electrodes on a side face of an insulating substrate, is fed into a holding recess of a positioning jig, there is no problem in a case of a posture in which a main face of the insulating substrate (front-face electrode forming face or rear-face electrode forming face) faces downward, but it becomes difficult to bring electrodes thereof into close contact with cream solder on solder lands of a circuit board in a case of a posture in which a side face of the insulating substrate faces downward within the holding recess, resulting in a shortage of soldering strength.

Patent reference 1: Japanese Unexamined Patent Application Publication No. 5-13201; pages 2-3, and FIG. 1

### DISCLOSURE OF THE INVENTION

### Problems to be Solved by the Invention

In the above described conventional chip resistor 1, it is intended that soldering strength can be kept even when the chip resistor is mounted on the circuit board in a horizontal position with a side face of the insulating substrate 2 facing downward, by forming the side-face electrodes 7 during forming a thick film for the end-face electrodes 6. In an actual manufacturing process, however, it is not easy to control an appropriate amount of conductive paste for the end-face electrodes 6 to flow into dividing grooves of the large size substrate for the side-face electrodes 7. Therefore, frequently formed are the side-face electrodes 7, which have sizes insufficient to keep soldering strength when the chip resistor is mounted in a horizontal position. Also, the sizes of side-face electrodes 7 become easily irregular, and therefore it is hard to say that the chip resistor has a good appearance. Further, since the width of the insulating substrate 2 is larger than the thickness thereof, a part of the insulating substrate 2 projects upward significantly from a positioning jig, when the chip resistor is arranged in a holding recess of the positioning jig (template) in a horizontal position. Thereby, there arises a problem that a sucking nozzle and the chip resistor 1 are easily damaged by a mechanical shock in a mounting process.

Also, miniaturization of chip resistors has been promoted recently and extremely small chip resistors having a longitudinal dimension of 1 mm and a thickness dimension of 0.5 mm are in widespread use. In a manufacturing process of such an extremely small chip resistors, it is difficult to form a thick film precisely for end-face electrodes on a strip substrate and a method to form a thin film for the end-face electrodes by sputtering is widely applied. When end-face electrodes are formed by sputtering, however, side-face electrodes can not be formed within dividing grooves at the same time and soldering strength becomes insufficient in a case the chip resistor is mounted on a circuit board in a horizontal position.

The present invention is achieved in view of such a situation in a prior art. A first object thereof is to provide a chip resistor, which easily keeps soldering strength even if mounted in a horizontal position, and never projects from a holding recess of a positioning jig in a mounting process, and further does not hinder miniaturization thereof from being promoted while keeping a good appearance thereof. Also a second object of the present invention is to provide a preferable method for manufacturing the chip resistor.

### Means for Solving the Problems

For achieving the above described first object, A chip resistor with a rectangular shape, according to the present invention, manufactured in a number of pieces at the same time by dividing a large size substrate, on both front face and rear face of which V-shaped grooves, first dividing grooves and second dividing grooves, are formed in a matrix, along the first grooves and the second grooves sequentially; the chip resistor comprising: a square-prism shaped insulating base with an approximately square cross section perpendicular to a longitudinal direction thereof; a pair of front-face electrodes provided on an approximately rectangular front face of this insulating base at both ends in the longitudinal direction thereof; a resistor provided on the front face of the insulating base, both ends of the resistor overlapping the pair of front-face electrodes; a protecting layer covering this resistor; a pair of rear-face electrodes provided on a rear face of the insulating base at both ends in the longitudinal direction thereof; and a pair of end-face electrodes provided on both approximately square end faces of the insulating base and bridge-connecting the front-face electrodes and the rear-face electrodes, the rear-face electrodes being extended to inclined faces formed as parts of the second dividing grooves at both lateral edges on the rear face of the insulating base along the longitudinal direction thereof.

According to such a configuration, there are extended rear-face electrodes on divided faces along the second dividing grooves in the side faces of the chip resistor and this extended electrodes are made to be side-face electrodes. Further, since the rear-face electrodes including the extended parts (side-face electrodes) can be printed precisely in a phase of a large size substrate, it is possible to form these extended parts in a desired size to keep a good appearance of the chip resistor and also it is easy to keep soldering strength required in a case the chip resistor is mounted in a horizontal position. Also, since the extended parts of the rear-face electrodes are made to be the side-face electrodes in this manner, the end-face electrodes may be formed by sputtering and can accommodate advancement in miniaturization of chip resistors without difficulty. Further, the insulating base of this chip resistor has a shape like a square prism having approximately square end faces at both ends, and, even in a horizontal position with any side face of the square prism facing downward within a holding recess of a positioning jig (template) in a mounting process, the chip resistor does not project from the holding recess significantly and there is no possibility that a sucking nozzle and the chip resistor are damaged in the mounting process.

In the above described configuration, the inclined faces formed as parts of the second dividing grooves at both lateral edges on the rear face of the insulating base (rear-face electrode forming face) along the longitudinal direction thereof are preferably made larger than those formed as parts of the second dividing grooves at both side faces on the front face of the insulating base (front-face electrode forming face) along the longitudinal direction thereof. That is, a face having deeper V-shaped grooves is preferably selected as a rear-face electrode forming face from the front face and the rear face of the large size substrate, both of which have the second dividing grooves, for easily obtaining required areas for the extended parts of the rear-face electrodes (the side-face electrodes).

Also, for achieving the above described second object, a method for manufacturing according to the present invention includes: an electrode forming step of forming a number of front-face electrodes on a front face of a large size substrate, V-shaped grooves, first dividing grooves and second dividing grooves, being formed in a matrix on both front face and rear face of the substrate, the front-face electrodes crossing the first dividing grooves and neighboring the second dividing grooves, and also of forming a number of rear-face electrodes on the rear face of the large size substrate, the rear-face electrodes crossing the second dividing grooves and neighboring the first dividing grooves; a resistor forming step of forming a number of resisters, both ends of the resistor overlapping the front-face electrodes, on the front face of the large size substrate; a protecting layer forming step of forming a protecting layer covering the resisters; an end-face electrode forming step of forming, after dividing the large size substrate provided with the protecting layer along the first dividing groves into strip substrates, end-face electrodes on divided faces thereof to bridge-connect the front-face electrodes and the rear-face electrodes; and a plating step of plating, after dividing the strip substrates provided with the end-face electrodes along the second dividing grooves into square-prism shaped pieces, the front-face electrodes, rear-face electrodes and end-face electrodes in each of the pieces to complete a chip resistor, the large size substrate being set such that a short side length of each rectangle partitioned by the first dividing grooves and second dividing grooves is approximately the same as a thickness of the large size substrate, and also, in the electrode forming step, the rear-face electrodes being extended to the inclined faces of the V-shaped grooves as the second dividing grooves on a face of the rear-face electrode side of the large size substrate.

According to such a method for manufacturing, since a short side length of each rectangle partitioned by the first dividing grooves and the second dividing grooves is set to be approximately the same as the thickness of the large size substrate, a square prism shaped piece, which is obtained in a large number by dividing a strip substrate, has an approximately square cross section perpendicular to the longitudinal direction thereof. Therefore, even in a horizontal position with any side face of the square prism facing downward within a holding recess of a positioning jig (template) in a mounting process, the chip resistor does not project from the holding recess significantly and there is no possibility that a sucking nozzle and the chip resistor are damaged in a mounting process. Also, since the rear-face electrodes are extended to the inclined faces within V-shaped grooves of the second dividing grooves on the face of the rear-face electrode side of the large size substrate and these extended parts are made to be the side-face electrodes exposed on the side faces of the chip resistor, the end-face electrodes can be formed by sputtering in the end-face electrode forming process and it is possible to accommodate advancement of miniaturization of chip resistors without difficulty. Also, since the rear-face electrodes including the extended parts (side-face electrodes) can be printed precisely in a phase of a large size substrate, it is easy to form these extended parts into any desired size and, thereby, there is no possibility that an appearance of the chip resistor is damaged by the extended parts, and also it is possible to keep soldering strength required for a case the chip resistor is mounted in a horizontal position utilizing the extended parts.

In the above described method for manufacturing, the depth of the second dividing grooves is preferably larger in the second dividing grooves formed on the rear face (rear-face electrode forming face) than in the second dividing grooves formed on the front face (front-face electrode forming face) of the large size substrate. This means that a face having deeper V-shaped grooves is selected for forming the rear-face electrodes out of the front face and the rear face of the large size substrate, both of which have the second dividing grooves, and it becomes easy thereby to obtain required areas for the extended parts of the rear-face electrodes (side-face electrodes).

### ADVANTAGE OF THE INVENTION

Since, in a chip resistor according to the present invention, rear-face electrodes are extended to side faces of the chip resistor which are divided faces along second dividing grooves and the rear-face electrodes including these extended parts (side-face electrodes) can be printed precisely in a process using a large size substrate, it is possible to keep a good appearance of the chip resistor and also it is easy to keep soldering strength required for a case the chip resistor is mounted in a horizontal position. Also, since end-face electrodes may be formed by sputtering, it is possible to accommodate advancement in miniaturization of chip resistors without difficulty. Also, since an insulating base of this chip resistor is shaped like a square prism with approximately square face at both ends thereof, even in a horizontal position with any side face of the square prism facing downward within a holding recess of a positioning jig (template) in a mounting process, the chip resistor does not project from the holding recess significantly and there is no possibility thereby that a sucking nozzle and the chip resistor are damaged in the mounting process.

Also, since, in the method for manufacturing the chip resistor according to the present invention, a short side length of each rectangle partitioned by first dividing grooves and second dividing grooves is set to be approximately the same as the thickness of a large size substrate, a square prism shaped piece obtained by dividing a strip substrate has an approximately square cross section perpendicular to the longitudinal direction of the piece, and, even in a horizontal position with any side face of the square prism facing downward within a holding recess of a positioning jig (template) in a mounting process, the chip resistor does not project from the holding recess significantly and there is no possibility that a sucking nozzle and the chip resistor are damaged in the mounting process. Also, since rear-face electrodes are extended to the inclined faces of V-shaped grooves of the second dividing grooves on the face of the rear-face electrode side of the large size substrate and these extended parts are made to be side-face electrodes exposed on the side faces of the chip resistor, end-face electrodes may be formed by sputtering and it is possible to accommodate advancement in miniaturization of chip resisters without difficulty. Also, since the rear-face electrodes including the extended part (side-face electrode) can be printed precisely in a process using a large size substrate, it is possible to keep a good appearance of the chip resistor and it is easy to obtain soldering strength required for a case the chip resistor is mounted in a horizontal position.

### BEST MODES FOR CARRYING OUT THE INVENTION

An embodiment of the present invention will be described with reference to the drawings as follows. FIG. 1 is a perspective view of a chip resistor according to the present embodiment, FIG. 2 is a schematic cross-sectional diagram showing the chip resistor, FIG. 3 is a flow chart showing manufacturing steps of the chip resistor, FIGS. 4 to 6 are explanatory diagrams showing the method for manufacturing the chip resistor in step sequence, FIG. 7 is an explanatory diagram showing situations in which the chip resistor is fed into a template in two different positions, and FIG. 8 is a side view showing a situation in which the chip resistor is mounted on solder lands in a horizontal position.

The chip resistor 10 shown in these drawings is a rectangular chip resistor conforming to a multi-mounting method is mounted on solder lands 33 of a circuit board 32 in a large number at the same time with a sucking nozzle (not shown in the drawing), after having been fed from a transferring tube (not shown in the drawing) into a holding recess 31 of a template 30 which is a positioning jig (refer to FIGS. 7 and 8). As shown in FIGS. 1 and 2, this chip resistor 10 mainly includes: a square-prism shaped insulating base 11 with an approximately square faces at both ends in the longitudinal direction thereof a pair of front-face electrodes 12 which are provided on an approximately rectangular main face (front face) 11a of the insulating base 11 at both ends in the longitudinal direction thereof, a resistor 13 which is provided on the front face 11a of the insulating base 11 and both end faces of which overlap the pair of front-face electrodes 12, a protecting layer with a two-layer structure (glass coating layer 14 and over-coating layer 15) which covers the resistor 13, a pair of rear-face electrodes 16 which are provided on the other main face (rear face) 11b of the insulating base 11 at both ends in the longitudinal direction thereof, a pair of end-face electrodes 17 which are provided on both end faces of the insulating base 11 in the longitudinal direction thereof and bridge-connect the front-face electrodes 12 and the rear-face electrodes 16, and a plating layer with a two-layer structure (nickel plating layer 18 and tin plating layer 19) which is deposited on these front-face electrodes 12, rear-face electrodes 16 and end-face electrode 17; and the front-face electrodes 12, the end-face electrodes 17 and the rear-face electrodes 16 are provided at both ends of the insulating base 11 as approximately U-shaped continuous electrodes. Also, on a pair of approximately rectangular side faces 11c perpendicular to the front face 11a and the rear face 11b of the insulating base, side-face electrodes 16a which are extended parts of the rear-face electrodes 16 are provided at positions neighboring the rear face 11b at both ends in the longitudinal direction thereof.

This chip resistor 10 is manufactured in a large number of pieces at the same time using a large size substrate 20 as shown in FIG. 4. First dividing grooves 21 and second dividing grooves 22, which are V-shaped grooves, are formed in a matrix on both of the front and rear faces of the large size substrate 20, and a number of rectangular regions 23 partitioned by both of the dividing grooves 21 and 22 on both of the front and the rear faces correspond to chip resistors 10, respectively. Also, as described hereinafter, while the front-face electrodes 12 and the rear-face electrodes 16 (including the side-face electrodes 16a) of the chip register 10 are formed by using thick films printed and baked on the large size substrate 20, the end-face electrodes 17 are formed using a thin film sputtered on divided faces of the large size substrate 20.

Next, a method for manufacturing a chip resistor 10 with such a configuration will be described with reference to a flow chart in FIG. 3 and process drawings in FIGS. 4 to 6.

First, in step S1 as shown in FIG. 4A, a large size substrate 20 made of ceramic or the like is prepared for obtaining a number of pieces. Both of the front and rear faces of the large size substrate 20 are preliminarily provided with first dividing grooves 21 and second dividing grooves 22, which are V-shaped grooves, in a matrix, and a number of rectangular regions 23 are partitioned by both of the dividing grooves 21 and 22. Since a short side length of this rectangular region 23 is set to be approximately the same as the thickness of the large size substrate 20, each chip resistor 10 has approximately square faces at both ends in the longitudinal direction of an insulating base 11. Also, while dividing grooves are generally different in depth between a front face 20a and a rear face 20b in this type of large size substrate 20, the rear face 20b with deeper grooves is used for rear-face electrode forming face in the present embodiment.

Next, in step S2 as shown in FIG. 4B, Ag or Ag—Pd paste is screen-printed and baked on the rear face 20b of the large size substrate 20 to form a number of rear-face electrodes 16 which correspond to the chip resistors 10, respectively. At this time, since the rear-face electrodes 16 are formed so as to cross the second dividing grooves 22 and to neighbor the first dividing grooves 21, the rear-face electrodes 16 are extended to inclined faces of the V-shaped grooves as the second dividing grooves 22 on the rear face 20b of the large size substrate 20, and these extended parts become side-face electrodes 16a.

Next, in step S3 as shown in FIG. 4C, Ag or Ag—Pd paste is screen-printed and baked on the front face 20a of the large size substrate 20 to form a number of front-face electrodes 12 which correspond to the chip resisters 10, respectively. At this time, the front-face electrodes 12 are formed so as to cross the first dividing grooves 21 and to neighbor the second dividing grooves 22. That is, there are no extended electrodes within the first dividing grooves 21 and the second dividing grooves 22 in either of the front face or the rear face of the large size substrate 20, and dividing along the first dividing grooves 21 and dividing along the second dividing grooves 22 are thereby carried out without problems. Note that either of the rear-face electrode forming step of the step S2 or the front-face electrode forming step of the step S3 may be carried out first.

Next, in step S4 as shown in FIG. 5A, resistor paste such as ruthenium oxide is screen-printed and baked on the front face 20a of the large size substrate 20 to form a number of resistors 13 which bridge-connect the front-face electrodes 12 neighboring each other in the longitudinal direction of the rectangular regions 23. Note that, since it is only required for the resistors 13 that both ends thereof are to overlap the front-face electrodes 12, the resistor forming step of the step S4 may be carried out before the front-face electrode forming step of the step S3.

Next, in step S5 as shown in FIG. 5B, glass paste is screen-printed and baked so as to cover each of the resistors 13 to form a glass coating layer 14, and resistance in each of the resistors 13 is adjusted by laser trimming as required. After that, in step S6 as shown in FIG. 5C, resin paste such as epoxy resin is screen-printed and heated for hardening to form an over-coating layer 15 which extends in strips covering the glass coating layer 14.

While the above described steps are bulk processing for the large size substrate 20, in the next step S7, the large size substrate 20 is divided into strips along the first dividing grooves 21 in a first dividing process and strip substrates 24 as shown in FIG. 6A are obtained. In the next step S8, nickel-chromium (Ni/Cr) is sputtered on exposed faces, which are divided faces in the first dividing process, of the strip substrates 24 to form end-face electrodes 17 with thin films which bridge-connect the front-face electrode 12 and the rear-face electrodes 16, respectively, as shown in FIG. 6B.

Next, in step S9, the strip substrates 24 are divided along the second dividing grooves 22 into pieces in a second dividing process, and a single chip 25 is obtained as shown in FIG. 6C. Then, in the next step S10, each single chip 25 is electro-plated to form two-layer structured plating layers 18, 19. That is, after the front-face electrodes 12, the rear-face electrodes 16 (including side-face electrodes 16a), and the edge-face electrodes 17 of the single chip 25 are provided with a nickel (Ni) plating layer 18, this nickel plating layer 18 is covered by a tin (Sn) plating layer 19 to complete a chip resistor 10 as shown in FIGS. 1 and 2. Note that, these plating layers 18 and 19 are provided in order to prevent electrodes from breaking and to improve soldering reliability, and a solder (Sn/Pb) plating layer can be used instead of the tin plating layer.

Since, in the chip resistor 10 manufactured in this manner, a short side length of each rectangular region 23 partitioned by the first dividing grooves 21 and the second dividing grooves 22 on the large size substrate 20 is set to be approximately the same as the thickness of the large size substrate 20, the single chip 25, which is obtained in a large number of pieces by dividing the strip substrates 24, has an approximately square cross section perpendicular to the longitudinal direction of the single chip 25, and the chip resistor 10 with an approximately square-prism shape is obtained. Therefore, a height of the chip resistor 10, within a holding recess 31 of a template (positioning jig) 30 in a mounting process of a multi-mounting method is about the same even in a horizontal position in which a face 11C faces upward as shown in FIG. 7A as in a regular position in which the side face 11a (or side face 11b) faces upward as shown in FIG. 7B. That is, even in a position with any face of the chip resistor 10 with a square-prism shape facing downward within the holding recess 31 of the template 30, this chip resistor 10 does not project from the holding recess 31 significantly and, thereby, there is no possibility that a sucking nozzle and the chip resistor 10 are damaged in a mounting process on a circuit board 32.

Also, since the rear-face electrodes 16 are extended to the inclined faces of the V-shaped grooves as the second dividing grooves 22 formed on the rear face 20b of the large size substrate 20 in the rear-face electrode forming step during manufacturing this chip resistor 10, and this extended parts are made to be the side-face electrodes 16a exposed on the side faces 11c of the chip resistor 10, the end-face electrodes 17 are formed by sputtering in the end-face electrode forming process to accommodate advancement in miniaturization of chip resistors without difficulty. Also, since the rear-face electrodes 16 including the side-face electrodes 16a (extended parts) can be printed precisely in the phase of the large size substrate 20, it is easy to form these side-face electrodes 16a so as to have any desired size. Thereby, there is no possibility that an appearance of the chip resistor 10 is damaged by the side-face electrodes 16a, and it is possible to obtain soldering strength required for a case the chip resistor 10 is mounted in a horizontal position, using the side-face electrodes 16a. That is, although the chip resistor 10, disposed in the holding recess 31 of the template 30 in a state shown in FIG. 7A, is fed onto solder lands 33 of the circuit board 32 in a horizontal position by a sucking nozzle (not shown in the drawing) as shown in FIG. 8, and a side face 11c of the insulating base 11 other than faces forming the front-face electrodes 12 and the rear-face electrodes 16 is mounted on the cream solder 34, satisfactory solder-fillets are formed extending from the side-face electrodes 16a to the rear-face electrodes 16 by heat-melting the cream solder 34, and sufficient soldering strength can be obtained, since the side-face electrode 16a is exposed at a part of this side face 11c.

Note that, if a face having deeper V-shaped grooves is selected as the rear-face-electrode forming face out of the front face and the rear face of the large size substrate 20, on both of which the second dividing grooves 22 are formed, as in the present embodiment, areas required for the side-face electrodes 16a, which are formed as parts of the rear-face electrodes 16 by printing, is easily obtained preferably.

### BRIEF DESCRIPTION OF THE DRAWINGS

FIG. 1 is a perspective view of a chip resistor according to an embodiment of the present invention

FIG. 2 is a schematic cross-sectional diagram of the chip resistor.

FIG. 3 is a flow chart showing manufacturing steps of the chip resistor.

FIG. 4 is an explanatory diagram showing the method for manufacturing in step sequence.

FIG. 5 is an explanatory diagram showing the method for manufacturing in step sequence.

FIG. 6 is an explanatory diagram showing the method for manufacturing in step sequence.

FIG. 7 is an explanatory diagram showing a situation in which the chip resistor is fed into a template in two different positions.

FIG. 8 is a side view showing a situation in which the chip resistor is mounted on solder lands in a horizontal position.

FIG. 9 is a perspective view of a chip resistor according to a conventional example.

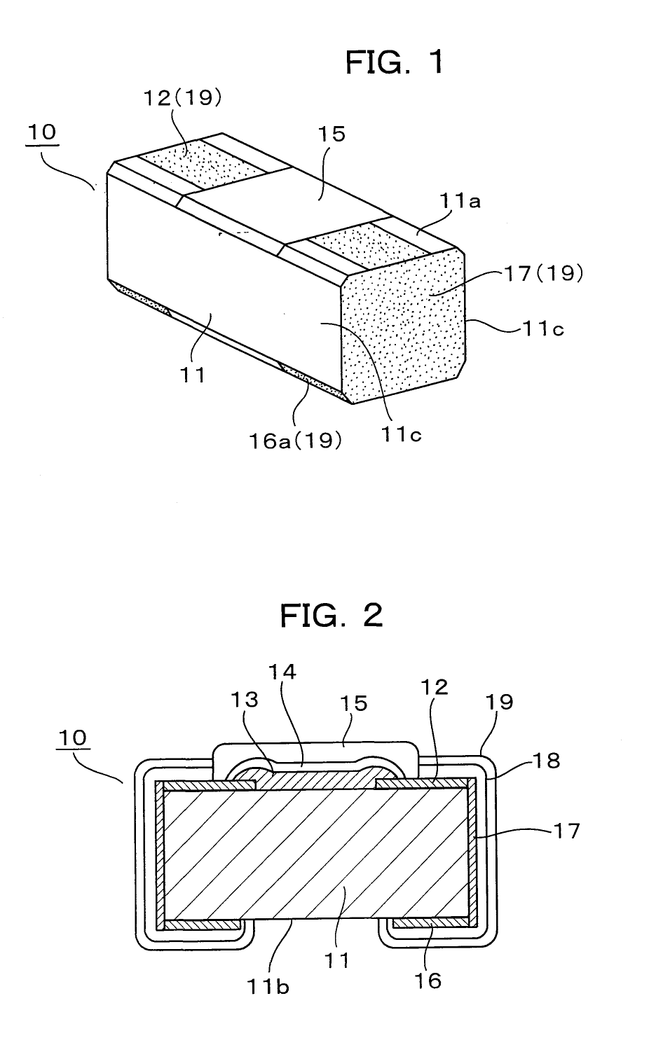

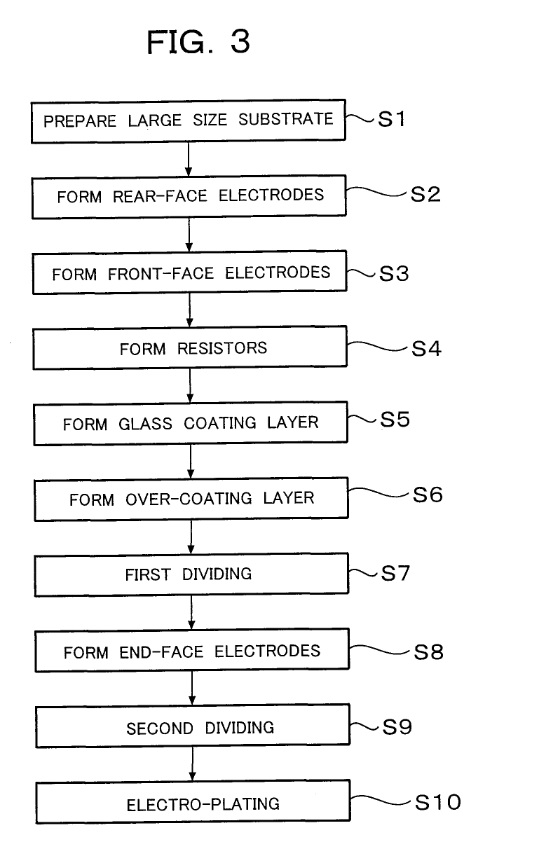

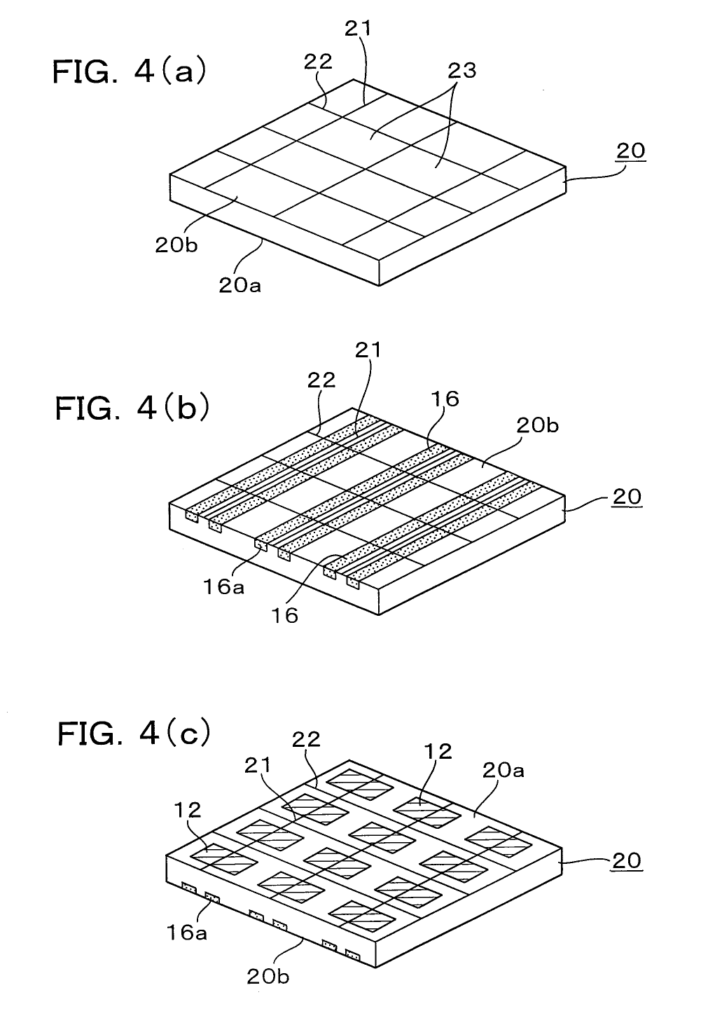

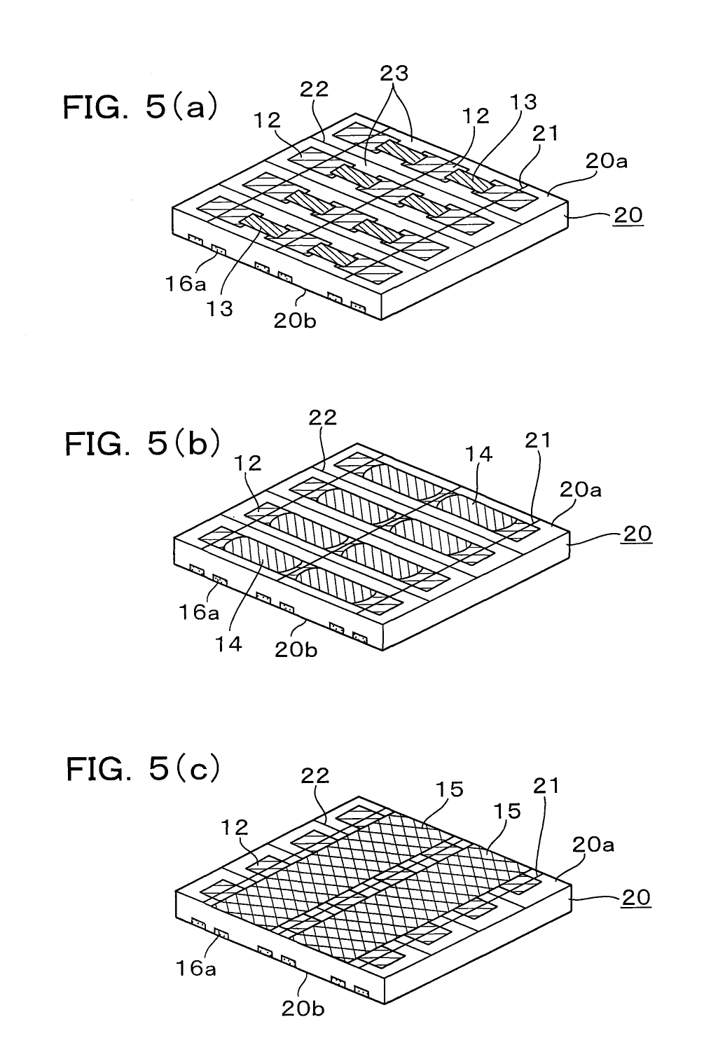

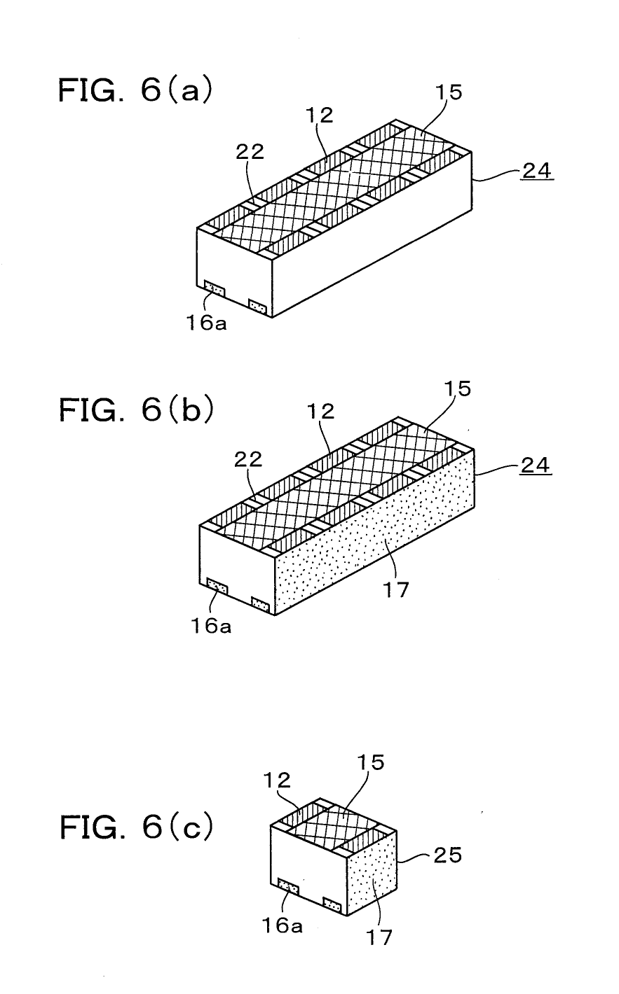

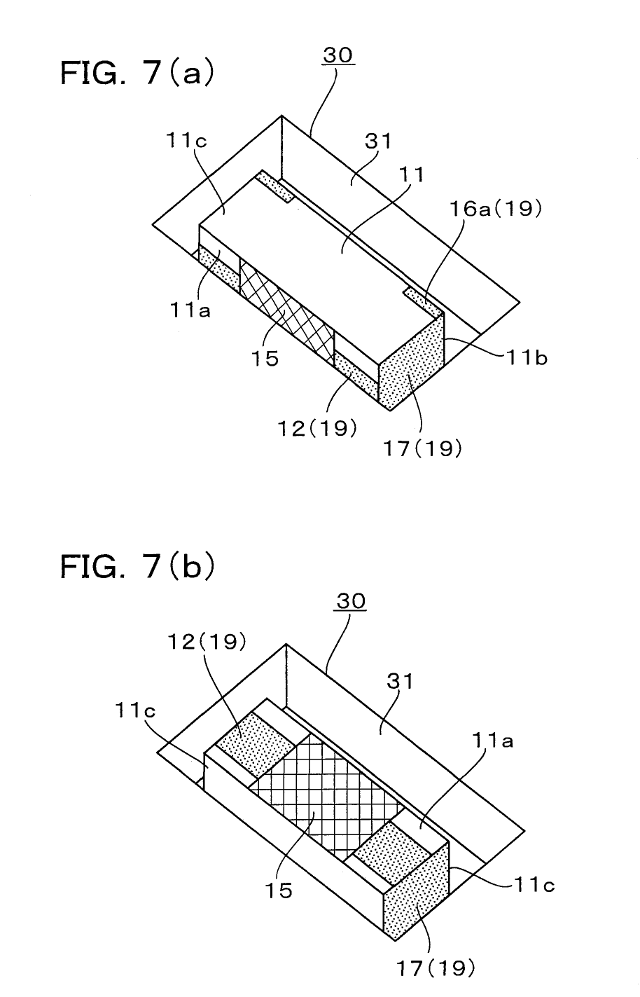

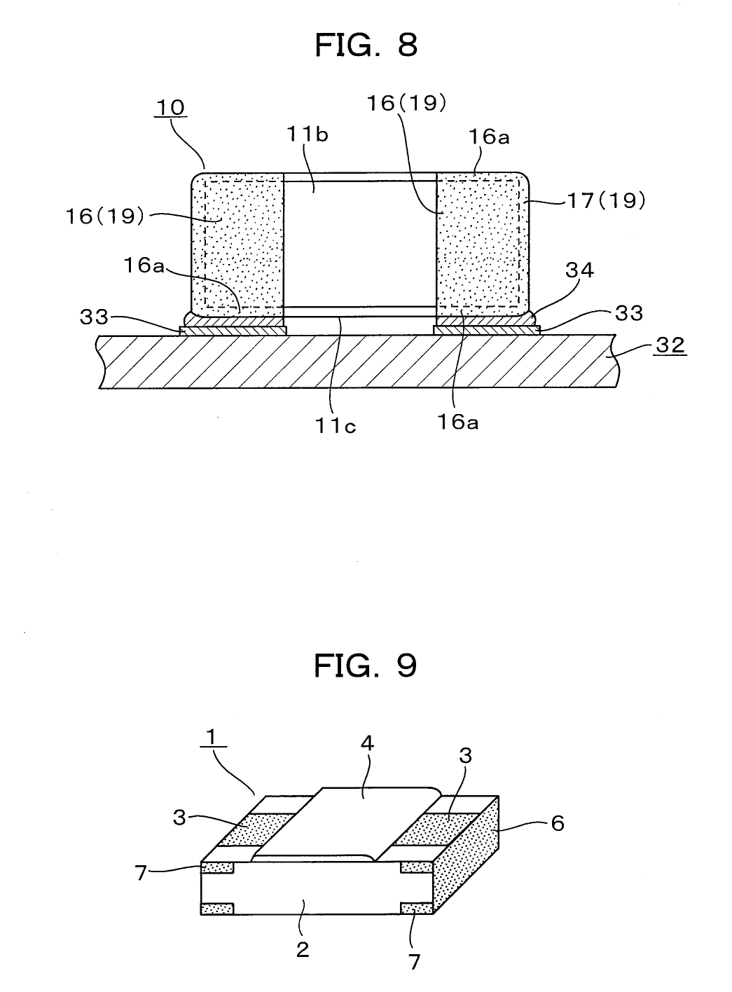

### DESCRIPTION OF THE REFERENCE NUMERALS

10 chip resistor
11 insulating base
12 front-face electrode
13 resistor
14 and 15 protecting layer
16 rear-face electrode
16a side-face electrode (extended part)
17 end-face electrode
18 and 19 plating layer
20 large size substrate
20a front face
20b rear face
21 first dividing groove
22 second dividing groove
24 strip substrate
30 template (positioning jig)
31 holding recess
32 circuit board
33 solder land
34 cream solder

1. A chip resistor with a rectangular shape, manufactured in a number of pieces at the same time by dividing a large size substrate, on both front face and rear face of which V-shaped grooves, first dividing grooves and second dividing grooves, are formed in a matrix, along said first grooves and said second grooves sequentially; said chip resistor comprising:
a square-prism shaped insulating base with an approximately square cross section perpendicular to a longitudinal direction thereof; a pair of front-face electrodes provided on an approximately rectangular front face of this insulating base at both ends in the longitudinal direction thereof; a resistor provided on the front face of said insulating base, both ends of said resistor overlapping said pair c front-face electrodes; a protecting layer covering this resistor; a pair of rear-face electrodes provided on a rear face of said insulating base at both ends in the longitudinal direction thereof; and a pair of end-face electrodes provided on both approximately square end faces of said insulating base and bridge-connecting said front-face electrodes and said rear-face electrodes,
said rear-face electrodes being extended to inclined faces formed as parts of said second dividing grooves at both lateral edges on the rear face of said insulating base along the longitudinal direction thereof.

2. The chip resistor according to claim 1, wherein said inclined faces are made larger than those formed as parts of said second dividing grooves at both lateral edges on the front face of said insulating base along the longitudinal direction thereof.

3. A method for manufacturing a chip resistor, comprising:
an electrode forming step of forming a number of front-face electrodes on a front face of a large size substrate, V-shaped grooves, first dividing grooves and second dividing grooves, being formed in a matrix on both front face and rear face of said substrate, said front-face electrodes crossing said first dividing grooves and neighboring said second dividing grooves, and also of forming a number of rear-face electrodes on the rear face of said large size substrate, said rear-face electrodes crossing said second dividing grooves and neighboring said first dividing grooves;
a resistor forming step of forming a number of resisters, both ends of said resistor overlapping said front-face electrodes, on the front face of said large size substrate;
a protecting layer forming step of forming a protecting layer covering said resisters;
an end-face electrode forming step of forming, after dividing said large size substrate provided with said protecting layer along said first dividing groves into strip substrates, end-face electrodes on divided faces thereof to bridge-connect said front-face electrodes and said rear-face electrodes; and
a plating step of plating, after dividing said strip substrates provided with said end-face electrodes along said second dividing grooves into square-prism shaped pieces, said front-face electrodes, rear-face electrodes and end-face electrodes in each of the pieces to complete a chip resistor,
said large size substrate being set such that a short side length of each rectangle partitioned by said first dividing grooves and second dividing grooves is approximately the same as a thickness of the large size substrate, and also, in said electrode forming step, the rear-face electrodes being extended to the inclined faces of the V-shaped grooves as said second dividing grooves on a face of said rear-face electrode side of said large size substrate.

4. The method for manufacturing a chip resistor according to claim 3, wherein a depth of said second dividing grooves is larger in the second dividing grooves formed on the rear face than in the second dividing grooves formed on the front face of said large size substrate.

5. The method for manufacturing a chip resistor according to claim 3 or 4, wherein said end-face electrodes are formed
